(19) United States
(12) Patent Application Publication
(10) Pub. No.: US 2026/0268462 A1
(43) Pub. Date: Sep. 10, 2026

(54) METHOD FOR CONVERTING AN INPUT IMAGE INTO AN OUTPUT IMAGE AND ASSOCIATED IMAGE CONVERTING DEVICE

(71) Applicant: FONDATION B-COM, Cesson-Sévigné (FR)

(72) Inventors: Olivier WEPPE, Cesson-Sévigné (FR); Foteini Tania POULI, Le Rheu (FR); Stéphane PAQUELET, Rennes (FR)

(21) Appl. No.: 19/167,304

(22) PCT Filed: Mar. 22, 2023
(86) PCT No.: PCT/IB2023/000139

§ 371 Date: Sep. 19, 2025

(51) Int. Cl. G06T 5/92; G06T 5/50

(52) U.S. Cl. CPC G06T 5/92; G06T 5/50; G06T 2207/20081; G06T 2207/20084

(57) ABSTRACT

An image converting device converts an input image having a first dynamic range into an output image having a second dynamic range. The device includes: a statistical module determining a statistical value associated with the input image based on first pixel values representing the input image; and a processing module based on an artificial neural network, the processing module determining pixel values of second pixel values associated with one pixel value of the first pixel values by applying the pixel value of the first pixel values to a first input node of the artificial neural network and the determined statistical value to a second input node of the artificial neural network, the artificial neural network providing, on an output node, the pixel value of the second set of pixel values representing the output image. A corresponding method for converting an input image into an output image is also described.

This application represents the US national stage of PCT/IB2023/000139, filed Mar. 22, 2023.

### TECHNICAL FIELD OF THE INVENTION

The invention relates to the field of image processing.

More particularly, the invention relates to a method for converting an input image into an output image and an associated image converting device.

### BACKGROUND INFORMATION

Image processing devices have been proposed for converting an input image having a first dynamic range (for instance a “Standard Dynamic Range” or SDR) into an output image having a second dynamic range (for instance a “High Dynamic Range” or HDR) that is distinct from the first dynamic range. Such a conversion is generally called “tone expansion”. It has also been proposed to perform the conversion the other way round, a conversion generally called “inverse tone mapping”.

In such an image processing device, a mapping unit is provided for transforming an input luminance value associated with a pixel of the input image into an output luminance value associated with the corresponding pixel in the output image.

Usually, the mapping unit is configured to determine tone expansion parameters based on an analytical processing, for example calculation of statistics being typical of the input image.

It is also known to use, in the mapping unit, a neural network which provides, as output, luminance mapped values. Such a solution is described for instance in the article “HDR image reconstruction from a single exposure using deep CNNs”, de G. Eilertsen, J. Kronander, G. Denes, R. K. Mantiuk, and J. Unger, in ACM Trans. Graph., vol. 36, n° 6, 2017, and in the article “ExpandNet: A Deep Convolutional Neural Network for High Dynamic Range Expansion from Low Dynamic Range Content” de D. Marnerides, J. Hatchett, and K. Debattista, in Computer Graphics Forum, vol. 37, n° 2, 2018. However, such neural network uses, as input, the full image. The size of the neural network thus needs to be significant in order to be able to handle the resolution of the full image. Furthermore, a significant number of training data is also necessary in order to ensure proper implementation of the neural network.

### SUMMARY OF THE INVENTION

In this context, the invention provides a method for converting an input image having a first dynamic range into an output image having a second dynamic range distinct from the first dynamic range, said input image being represented by at least a first set of pixel values, said output image being represented by at least a second set of pixel values, the method comprising steps of:
determining at least one statistical value associated with the input image based on the first set of pixel values,
determining at least one pixel value included in the second set of pixel values and associated with one pixel value of the first set of pixel values by applying said pixel value of the first set of pixel values to a first input node of an artificial neural network and the determined statistical value to a second input node of the artificial neural network, the artificial neural network being configured to provide, on an output node, said pixel value of the second set of pixel values.

Use of an artificial neural network to perform the dynamic range conversion provides a solution with constant and relatively low complexity, even when the conversion follows a complex processing scheme.

In addition, applying at least one statistical value associated with the input image to a corresponding input node of the artificial neural network makes it possible to take into account the image as a whole in an efficient manner, and thus to apply pixel values to the artificial neural network on a pixel-by-pixel basis, which greatly reduces the dimension of the input layer of the artificial neural network, and thus the complexity of the latter, and strongly reduces the quantity of data needed to train the artificial neural network, as explained below.

Thanks to the proposed structure, a plurality of pixel values of the second set of pixel values may be determined by applying sequentially pixel values of the first set of pixel values on the first input node (the pixel values considered in sequence relating to the various pixels of the input image) while applying the determined statistical value to the second input node. Said differently, the application of the determined statistical value to the second input node is maintained while the pixel values of the first set of pixel values are successively considered and applied to the first input node of the artificial neural network.

The first set of pixel values may for instance define a component of the input image, such as a luminance component (or, in other embodiments, a colour component).

The second set of pixel values may thus define a corresponding component of the output image.

In some embodiments, such as described below, the artificial neural network may be configured to receive, on two other input nodes, two other pixel values respectively relating to two other components associated with the input image and to provide, on two other output nodes, two other pixel values respectively relating to two other corresponding components associated with the output image.

These two other components may be chrominance components (of the input image), in particular when the first set of pixel values corresponds to a luminance component of the input image.

According to other embodiments, the two other components may be colour components, in particular when the first set of pixel values corresponds to a colour components.

The method may further comprise a step of training the artificial neural network by successively using reference images as the input image. A reference statistical value may then be determined for each predetermined reference image.

The step of training may use reference output images respectively obtained from the reference images by dynamic range conversion, e.g. by processing the reference images using an analytical method.

In order to produce reference images as mentioned above, the step of training may comprise steps of:
determining initial images defined by a plurality of components according to a first representation (e.g. a representation using colour components, such as an RGB representation), pixel values of the initial images being uniformly distributed over all possible values relating to said plurality of components, and
converting the initial images defined by the plurality of components respectively into the reference images defined by another plurality of components according to a second representation (e.g. a representation using a luminance component and two chrominance components, such as a YCbCr representation).

The step of training may further comprise a step of applying a reshaping function to the pixel values of initial images such that the initial images correspond to different statistical values.

The step of training may then comprise a step of adjusting neuron weights of the artificial neural network to reduce a cost function depending on pixel values of the reference output image obtained based on a specific one of the reference images, and pixel values obtained at the output of the artificial neural network when pixel values of the specific one of the reference images are sequentially applied on the first input node of said artificial neural network.

The cost function may for instance be a perceptual (colour) difference metric.

In addition, the method may further comprise a step of training another artificial neural network by applying one pixel value of the second set of pixel values to a first node of said another artificial neural network and, to a second node of said another artificial neural network, another statistical value associated with the output image and determined on the basis of said second set of pixel values, the another artificial neural network being configured to provide, on an output node of the another artificial neural network, one pixel value of a third set of pixel values associated with said one pixel value of the second set of pixel values.

The step of training said another artificial neural network may then comprise a step of adjusting neuron weights of said another artificial neural network to reduce another cost function depending on pixel values of the third set of pixel values and on pixel values of the first set of pixel values.

The other neural network is thus trained such that, when the artificial neural network and the other artificial network are successively applied to a given image, the resulting image is similar to this given image, thus performing a so-called “roundtrip” without substantial change in the image.

Said another cost function may also be a perceptual (colour) difference metric.

The invention also provides an image converting device for converting an input image having a first dynamic range into an output image having a second dynamic range distinct from the first dynamic range, said input image being represented by at least a first set of pixel values, said output image being represented by at least a second set of pixel values, the image converting device comprises:
a statistical module configured to determine at least one statistical value associated with the input image based on the first set of pixel values,
a processing module based on an artificial neural network, the processing module being configured to determine at least one pixel value of the second set of pixel values that is associated with one pixel value of the first set of pixel values by applying said pixel value of the first set of pixel values to a first input node of the artificial neural network and the determined statistical value to a second input node of the artificial neural network, the artificial neural network being configured to provide, on an output node, said pixel value of the second set of pixel values.

Optional features described above in connection with the conversion method may also apply to this image converting device.

The invention also provides a method for processing a digital image defined on a matrix of pixels by three components each including a set of pixel values, the method using an artificial neural network comprising three pixel input nodes and at least one statistic input node, the method including the following steps:
determining a statistical value based on pixel values of at least one component among the three components;
while applying the determined statistical value to the statistic input node, considering the pixels in sequence and, for each pixel considered, applying three pixel values respectively representing the three components for the currently considered pixel respectively to the three pixel input nodes, thus producing three output pixel values relating to the currently considered pixel respectively on three output nodes of the artificial neural network.

Optional features mentioned above may also apply to this method.

### BRIEF DESCRIPTION OF THE DRAWINGS

The following description with reference to the accompanying drawings will make it clear what the invention consists of and how it can be achieved. The invention is not limited to the embodiment/s illustrated in the drawings. Accordingly, it should be understood that where features mentioned in the claims are followed by reference signs, such signs are included solely for the purpose of enhancing the intelligibility of the claims and are in no way limiting on the scope of the claims.

In the accompanying drawings:

FIG. 1 shows an example of an image processing device according to the invention;

FIG. 2 shows a system for training an artificial neural network used in the image processing device of FIG. 1;

FIG. 3 shows the main steps of a possible method for training this artificial neural network using the system of FIG. 2;

FIG. 4 shows the mains steps of a method of converting an input image into an output image according to a possible embodiment of the invention; and

FIG. 5 describes a system for training another neural network that can also be used to perform a dynamic range conversion.

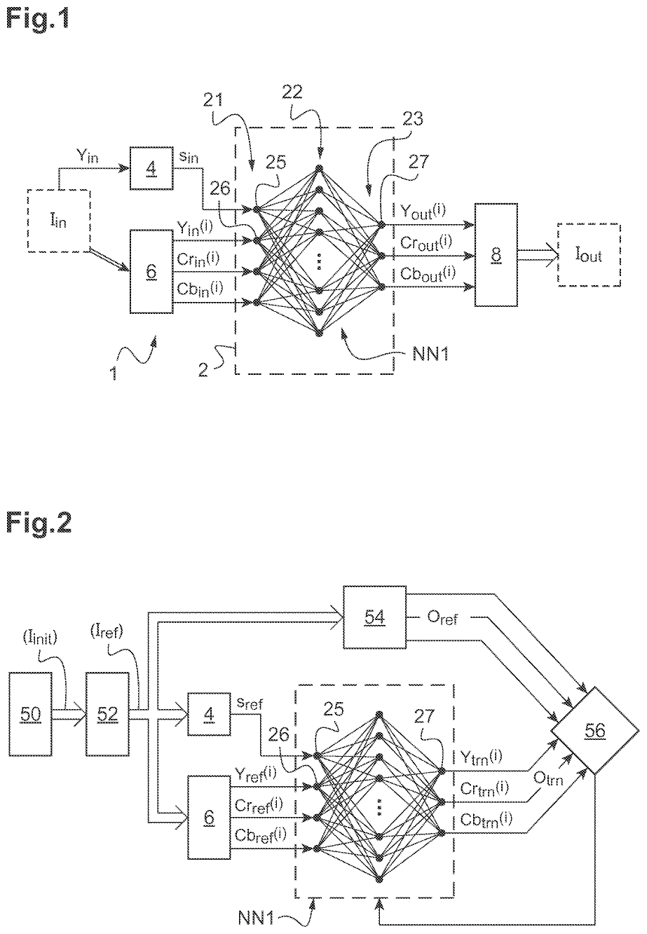

FIG. 1 shows an example of an image converting device according to the invention.

### DETAILED DESCRIPTION

This image converting device 1 may be implemented in practice by an electronic device including a processor and a memory storing program code instructions adapted to perform the operation and functions of the modules described below, when the concerned program code instructions are executed by the processor. In other embodiments, some of the modules described below may be implemented by an application specific integrated circuit or ASIC.

As it will be apparent from the following description, the image converting device 1 is designed to convert an input image Iᵢₙ having a first dynamic range Δ₁ (for instance a standard dynamic range or SDR) into an output image Iₒᵤₜ having a second dynamic range Δ₂ (for instance a high dynamic range or HDR) that is distinct from the first dynamic range.

For example here, the second dynamic range Δ₂ is larger than the first dynamic range Δ₂. Such a process of converting an input image Iᵢₙ having a first dynamic range Δ₁ into an output image Iₒᵤₜ having a second dynamic range Δ₂ larger than the first dynamic range Δ₁ is generally referred to as “tone expansion”.

As an alternative, the image converting device can be used to provide the opposite conversion, thus converting an input image having a high dynamic range into an output image a standard dynamic range. Such a process of conversion is generally referred as “inverse tone mapping”.

The input image Iᵢₙ is represented by at least a first set of pixel values respectively associated with a set of pixels (generally a matrix of pixels) of the input image Iᵢₙ. This first set of pixel values may define a component (e.g. a luminance component Yᵢₙ) of the input image Iᵢₙ.

The input image Iᵢₙ is for instance defined by a plurality of components (here three components Yᵢₙ, Crᵢₙ, Cbᵢₙ), each component comprising a set of pixels values respectively associated with the pixels of the input image Iᵢₙ.

In the present example, the input image Iᵢₙ is represented by a luminance component Yᵢₙ and two chrominance components Crᵢₙ, Cbᵢₙ. In the following, pixel values of the luminance component and the (two) chrominance components associated to a given pixel i of the input image Iᵢₙ are respectively noted Yᵢₙ(i), Crᵢₙ(i), Cbᵢₙ(i).

Another representation may however be used for the input image Iᵢₙ, such as for instance using three colour components Rᵢₙ, Gᵢₙ, Bᵢₙ (namely a red component Rᵢₙ, a green component Gᵢₙ and a blue component Bᵢₙ).

As visible in FIG. 1, the image converting device 1 includes a processing module 2 configured (as explained below) to determine at least one pixel value of a second set of pixel values associated with the output image Iₒᵤₜ.

For that purpose, the processing unit 2 is based on an artificial neural network NN1. Said differently, the processing unit 2 implements the artificial neural network NN1.

In the present example, the artificial neural network NN1 includes an input layer 21, a hidden layer 22 connected to both the input layer 21 and an output layer 23, and the output layer 23. Such an artificial neural network NN1 thus has a rather simple structure.

The input layer includes at least one pixel input node 26 and at least one statistic input node 25. In the example shown in FIG. 1, the input layer 21 includes three pixel input nodes 26 (corresponding respectively to the three components of the input image Iᵢₙ) and at least one statistic input node (here a single statistic input node 25) The hidden layer 22 includes for instance between 30 neurons and 100 neurons, here 48 neurons.

Each neuron of the hidden layer 22 produces an output value based on the respective values of input nodes 25, 26. For instance, in the present embodiment, each neuron of the hidden layer 22 computes a weighted sum of values of input nodes 25, 26 and produces its output value by applying an activation function to this weighted sum. Weights involved in the weighted sum are determined thanks to a training phase as explained below. The activation function is for instance a Leaky Rectified Linear Unit activation function (or LReLU activation function). The slope of the Leaky ReLU activation function is here comprised between 0.1 and 0.2 (e.g. 0.125) in order to guarantee the compactness of the artificial neural network without a loss of performance.

The output layer 23 includes at least one neuron, forming an output node for the artificial neural network NN1. In the example shown in FIG. 1, the output layer 23 includes three neurons, respectively forming three output nodes 27 (corresponding respectively to the three components of the output image Iₒᵤₜ).

Each neuron of the output layer 23 produces an output value (i.e. a value of the concerned output node 27) based on values output from neurons of the hidden layer 22. For instance, in the present embodiment, each neuron of the output layer 23 computes a weighted sum of values output by neurons of the hidden layer 22, and produces its output value by applying an activation function to this weighted sum. Weights involved in the weighted sum are determined thanks to the training phase as explained below. The activation function is for instance a Leaky Rectified Linear Unit activation function (or LReLU activation function). The slope of the Leaky ReLU activation function is here comprised between 0.1 and 0.2 (e.g. 0.125) in order to guarantee the compactness of the artificial neural network without a loss of performance.

The image converting device 1 also includes a statistical module 4 configured to determine at least one statistical value sᵢₙ associated with the input image Iᵢₙ. More particularly, the statistical value sᵢₙ is determined at least based on the first set of pixel values. The statistical value sᵢₙ may be a measure of central tendency of (all) the pixel values of the first set of pixel values (defining the luminance component Yᵢₙ of the input image Iᵢₙ in the present embodiment). For example, the statistical value sᵢₙ may be the average of (all) the pixel values of the first set of pixel values (defining the luminance component Yᵢₙ of the input image Iᵢₙ in the present embodiment). The statistical value can also be the median of (all) the pixel values of the first set of pixel values (defining the luminance component Yᵢₙ of the input image Iᵢₙ in the present embodiment).

In other embodiments, the statistical module 4 may determine a plurality of statistical values, for instance values counting the respective numbers of pixels of the input image Iᵢₙ associated respectively with different (predetermined) luminance ranges (thus defining a histogram of luminance pixel values of the input image Iᵢₙ).

As visible in FIG. 1, the statistical value sᵢₙ produced by the statistical module 4 is applied to an input node (here the statistic input node 25) of the artificial neural network NN1. In embodiments where the statistical module 4 produces a plurality of statistical values, the statistical values are respectively applied to corresponding input nodes (statistic input nodes) of the artificial neural network NN1.

As represented in FIG. 1, the image converting device 1 comprises a sweeping module 6 configured to sequentially (i.e. successively) apply the (various) pixels values Yᵢₙ(i) of the first set of pixel values to an input node (here to one of the pixel input nodes 26) of the artificial neural network NN1. The sweeping module 6 sequentially applies the various pixel values Yᵢₙ(i) of the first set of pixel values to the (pixel) input node 26 while the statistical module 4 applies (i.e. keeps applying) the determined statistical value Sin to the (statistic) input node 25.

Each time a pixel value Yᵢₙ(i) of the first set of pixel values is applied to the concerned (pixel) input node 26 (while the statistical module 4 applies the determined statistical value sᵢₙ to the statistic input node 25), an (output) pixel value Yₒᵤₜ(i) of a second set of values defining the output image Iₒᵤₜ is provided on an output node 27 of the artificial neural network NN1.

In the present embodiment, while the statistical module 4 applies (i.e. keeps applying) the determined statistical value sᵢₙ to the (statistic) input node 25, the sweeping module 6 is configured to sequentially consider the pixels of the input image Iᵢₙ (one by one, and one after the other), for instance in a raster scan order, and, for each pixel i of the input image Iᵢₙ, to apply the pixel value Yᵢₙ(i) corresponding to the concerned pixel i in the first set of pixel values to a (pixel) input node 26 of the artificial neural network NN1 (as already explained), as well as, in the present case, the pixel value Crᵢₙ(i) corresponding to the concerned pixel i in the second component Crᵢₙ to a second (pixel) input node 26, and the pixel value Cbᵢₙ(i) corresponding to the concerned pixel i in the third component Cbᵢₙ to a third (pixel) input node 26 of the artificial neural network NN1.

In practice, to apply a given pixel value to an input node of the artificial neural network NN1, the sweeping module 6 for instance reads the concerned pixel value in a memory of the image converting device 1 and applies the read pixel value to the concerned input node 26.

Each time three pixel values Yᵢₙ(i), Crᵢₙ(i), Cbᵢₙ(i) representing the three components for a given pixel i are respectively applied to the (pixel) input nodes 26 of the artificial neural network NN1 (while the statistical module 4 applies the determined statistical value Sin to the statistic input node 25), three corresponding output pixels values Yₒᵤₜ(i), Crₒᵤₜ(i), Cbₒᵤₜ(i) representing the three components for the same pixel in the output image Iₒᵤₜ are produced on the three output nodes 27 of the artificial neural network NN1.

The image converting device 1 also includes an assembling module 8 configured to receive the output pixel values Yₒᵤₜ(i), Crₒᵤₜ(i), Cbₒᵤₜ(i) and to construct the output image Iₒᵤₜ.

In practice, the assembling module 8 may simply store the received output pixel values Yₒᵤₜ(i), Crₒᵤₜ(i), Cbₒᵤₜ(i) in the memory of the electronic device 1 following the order used by the sweeping module 6 (i.e. the raster scan order).

The output image Iₒᵤₜ thus obtained can then be displayed on a screen of the image converting device 1, or, as a variation, transmitted to an external electronic device (using a communication circuit of the image converting device 1).

Said differently, the electronic device implementing the image converting device 1 may be a display device including a screen suitable for displaying the output image Iₒᵤₜ. As a variation however, the electronic device may be a processing device with no display, possibly with a communication circuit for transmitting the component values Yₒᵤₜ, Crₒᵤₜ, Cbₒᵤₜ representing the output image Iₒᵤₜ to an external electronic device (that may include a screen suitable for displaying the output image Iₒᵤₜ).

FIG. 2 shows a system for training the artificial neural network NN1.

This system comprises an image generator 50, a component converter 52, an analytical converter 54, a cost estimator 56 and elements of the image converting device 1 already presented.

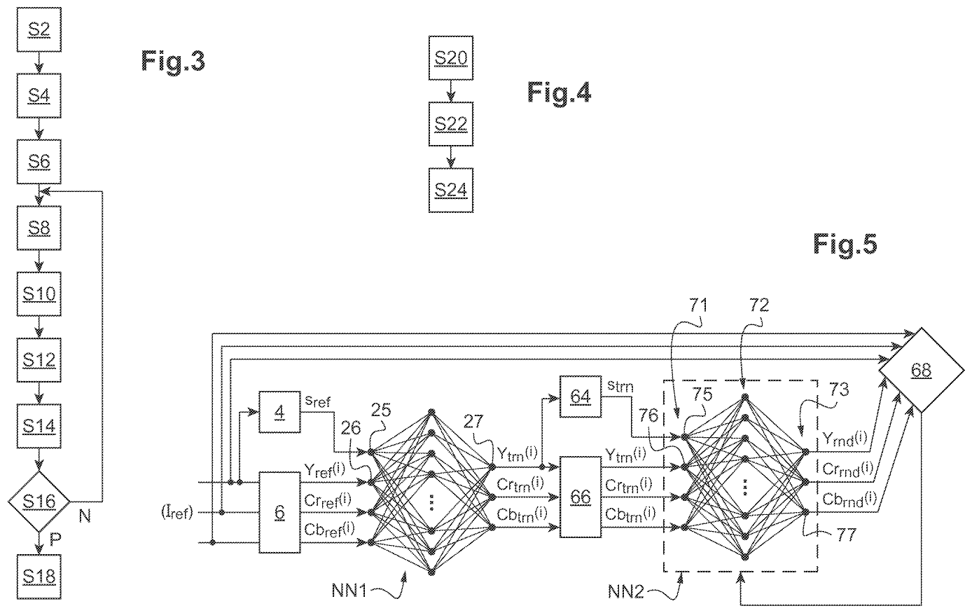

FIG. 3 shows the main steps of a possible method for training the artificial neural network NN1 using the system of FIG. 2.

In a step S2, the image generator 50 generates initial images Iᵢₙᵢₜ such that pixel values of the initial images are uniformly distributed over all possible values relating to the components of the image.

For instance, in a possible embodiment, the image generator 50 produces between 1,000 and 10,000 (e.g. 4,000) triplets of pixel values uniformly distributed in the space of possible values [0; 1023]×[0; 1023]×[0; 1023] (each triplet comprising respective pixels values for the various components considered, here for a red component, a green component and a blue component).

The image generator 50 then generates at least one initial image Iᵢₙᵢₜ wherein the produced triplets are respectively associated to pixels of the initial image Iᵢₙᵢₜ. As spatial information is not used in the processing described here, any image dimensions may be used (hence the possibility to generate one initial image or a plurality of initial images).

In a step S4, the image generator 50 generates further initial images Iᵢₙᵢₜ by applying a reshaping function to the pixel values of previously produced initial images such that the initial images correspond to different statistical values.

For instance, in embodiments where the statistical value determined by the statistical module 4 is the average or the median of pixels values of an image, applying the reshaping function can comprise applying a multiplicative factor (gain) and/or exponentiate using an exponent (generally noted γ).

In the embodiment described here, a given number of distinct reshaping functions (e.g. applying several multiplicative factors) are applied to the initial image Iᵢₙᵢₜ produced at step S2 so as to obtain a same number of other initial images Iᵢₙᵢₜ having respectively distinct statistical values (e.g. 20 distinct statistical values ranging from 0 to 1023).

In a step S6, the initial images Iᵢₙᵢₜ (which each comprise three components in a given representation, here three colour components in the RGB-representation) are converted by component converter 52 into reference images I_{ref} using another representation, here a representation where reference images I_{ref} are represented by a luminance component Y and two chrominance components Cr, Cb.

In a step S8, a reference image I_{ref} is processed by the analytical converter 54. Analytical converter 54 is a circuit configured to convert an input image having the first dynamic range Δ₁ (here an SDR image) into an output image having the second dynamic range Δ₂ (here a HDR image) as taught in European patent application No. 3 839 876 or in PCT application No. WO 2021/123 284. Analytical converter 54 is thus configured to perform a dynamic range conversion, by mapping pixel values in the first dynamic range to pixel values in the second dynamic range (i.e. by applying to pixel values an increasing and continuous function mapping a first interval extending over the first dynamic range to a second interval extending over the second dynamic range).

The image output from analytical converter 54 is denoted reference output image O_{ref} in the following and is applied to the cost estimator 56 as explained below.

In a step S10, the same reference image I_{ref} is applied to the statistical module 4 such that the statistical module 4 determines a statistical value s_{ref} associated with the reference image I_{ref} (e.g. a measure of central tendency of pixel values of the luminance component of the reference image I_{ref}, such as the average or the median of these pixel values) and applies this statistical value s_{ref} to the (statistic) input node 25 of the artificial neural network NN1.

In a step S12, while the statistical module 4 is applying the statistical value s_{ref} to the (statistic) input node 25, the sweeping module 6 sequentially considers (all) the pixels of the reference image I_{ref} (processed in step S8 by the analytical converter 54 and in step S10 by the statistical module 4) and, for each pixel, applies the pixel values Y_{ref}(i), Cb_{ref}(i), Cr_{ref}(i) associated to the pixel i concerned (respectively here for the three components of the reference image I_{ref}) to the respective (pixel) input nodes 26 of the artificial neural network NN1.

Thus, in step S12, the output nodes 27 of the artificial neural network NN1 successively take pixel values (here triplet of pixel values: Yₜᵣₙ(i), Cbₜᵣₙ(i), Crₜᵣₙ(i)) defining the various pixels of a training output image Oₜᵣₙ, which is also applied to the cost estimator 56.

In a step S14, the cost estimator 56 estimates a loss (or cost function) between the reference output image O_{ref} and the training output image Oₜᵣₙ and controls an adjustment of the weights of the neurons of the artificial neural network NN1 to reduce this loss (in accordance with a back-propagation technique).

The cost function used for determining the loss (based on the pixels values of the reference output image O_{ref} and the pixel values of the training output image Oₜᵣₙ) is for instance a perceptual (possibly colour) difference metric between the reference output image O_{ref} and the training output image Oₜᵣₙ. Using such a metric, more weight is put on the perceived differences between the two images, while relaxing the constraints on differences that have limited impact on the visual perception of the result.

According to a possible embodiment, the perceptual difference metric used is the AEITP colour difference metric as described in the ITU-R BT.2124 recommendation. In an alternative implementation, a colour difference metric such as the CIEDE2000 colour difference may be used (see e.g. “The development of the CIE 2000 colour-difference formula: CIEDE2000”, by M. R. Luo, G. Cui, and B. Rigg in Color Res. Appl., 2001). In yet another implementation, metrics such as the HDR-VDP metric or the HDR-VDP-2 metric could be used (see in this respect the article “HDR-VDP-2: A calibrated visual metric for visibility and quality predictions in all luminance conditions”, by R. Mantiuk, K. J. Kim, A. G. Rempel & W. Heidrich in ACM Transactions on Graphics, Volume 30, Issue 4, Article No. 40, pp 1-14).

In a step S16, it is determined whether all reference images I_{ref} have been processed through steps S8 to S14. If not (arrow N), the method loops to step S8 to process another reference image.

If all reference images have been processed (arrow P), the method end at step S18.

Training thus makes it possible for the artificial neural network NN1 to perform the same conversion as the analytical converter 54. The calculation complexity of the artificial neural network NN1 remains low, even when a complex processing is performed by the analytical converter 54.

As pixel values relating to a single pixel are applied at a time to (pixel) input nodes 26 of the neural network NN1, training is efficient (compared in particular to solutions where pixels values representing a whole image are applied simultaneously to corresponding input nodes of an artificial neural network). In particular, as explained above, the artificial neural network NN1 is trained using several thousands of values each time a reference image is processed for training.

FIG. 4 shows the mains steps of a method of converting an input image into an output image using the artificial neural network NN1. In the present example, this method is performed by the image converting device 1 described above.

As already explained in connection with FIG. 1, the input image Iᵢₙ is defined by at least a first set of pixel values (corresponding here to luminance values Yᵢₙ(i) of the pixels of the input image Iᵢₙ); specifically, in the embodiment described, the input image Iᵢₙ includes three components (a luminance component Yᵢₙ and two chrominance components Crᵢₙ, Cbᵢₙ), each component being defined by a set of pixel values respectively associated with pixels of the input image Iᵢₙ.

The method of FIG. 4 includes a step S20 in which the statistical module 4 determines a statistical value sᵢₙ associated with the input image Iᵢₙ based on the first set of pixel values. This statistical value is for instance a measure of central tendency, such as the average (or, in another example, the median), of the pixel values Yᵢₙ(i) of the first set of pixel values.

As already noted, in other embodiments, several statistical values may be determined by the statistical module 4 at step S20. These statistical values may define a histogram characterizing the pixel values of the first set of pixel values.

The method of FIG. 4 then includes a step S22 in which the statistical module 4 applies the determined statistical value sᵢₙ to an input node (here the statistic input node 25) of the artificial neural network NN1.

In embodiments where several statistical values are determined by the statistical module 4, step S22 includes respectively applying the various statistical values to a plurality of corresponding (statistic) input nodes of the artificial neural network NN1.

While the statistical value(s) is (are) applied to the statistic input node(s) 25 of the artificial neural network NN1, the sweeping module 6 sequentially applies the various pixel values of the first set of pixel values to a particular (pixel) input node 26 of the artificial neural network NN1 (step S24).

For each pixel value applied on the (pixel) input node 26, a corresponding output value is produced on a particular output node 27 of the artificial neural network NN1. Thus, by sequentially applying the pixel values Yᵢₙ(i) of the first set of pixel values on the (pixel) input node 26, this particular output node 27 produces a sequence of output values Yₒᵤₜ(i) respectively corresponding to a pixel value Yᵢₙ(i) of the first set of pixel values.

These output values (produced by the concerned output node 27 as a sequence) form a second set of pixel values respectively associated with pixel values of the first set of pixel values. This second set of pixel values define at least in part the output image Iₒᵤₜ.

Thanks to the training of the artificial neural network NN1 described above, the second set of pixel values have a second dynamic range (here a High Dynamic Range) that is different (here: is larger) than a first dynamic range (here a Standard Dynamic Range) of pixel values of the first set of pixel values.

In the embodiment of FIG. 1, the artificial neural network NN1 includes a number of pixel input nodes 26 equal to the number of components defining the input image Iᵢₙ, i.e. three pixel input nodes 26.

Thus, in step S24, while the statistical value(s) is (are) applied to the (respectively corresponding) statistic input node(s) 25 of the artificial neural network NN1, the sweeping module 6 sequentially considers the various pixels of the input image Iᵢₙ and, for each pixel i, applies pixel values Yᵢₙ(i), Cbᵢₙ(i), Crᵢₙ(i) respectively defining the three components Yᵢₙ, Cbᵢₙ, Crᵢₙ of the input image Iᵢₙ for the concerned pixel i to the corresponding (pixel) input nodes 26 of the artificial neural network NN1.

Each time a triplet of pixel values (corresponding to a particular pixel of the input image Iᵢₙ) is applied to the pixel input nodes 26 of the artificial neural network NN1, the artificial neural network NN1 produces a plurality of output values (here three output values Yₒᵤₜ(i), Cbₒᵤₜ(i), Crₒᵤₜ(i) respectively on the plurality of output nodes 27 of the artificial neural network NN1 (i.e. here on the three output nodes 27 of the artificial neural network NN1).

Thus, sequentially applying triplets of pixel values on the pixel input nodes 26 makes it possible to generate, on each output node 27, a sequence of output values, i.e., considering the plurality of output nodes 27, a sequence of triplets of output values Yₒᵤₜ(i), Crₒᵤₜ(i), Cbₒᵤₜ(i) respectively corresponding to the triplets of pixel values defining the three components (here a luminance component Yₒᵤₜ and two chrominance components Crₒᵤₜ, Cbₒᵤₜ) of the output image Iₒᵤₜ.

FIG. 5 describes a system for training another neural network NN2 that can also be used to perform a dynamic range conversion.

Precisely, as will become apparent from the explanation below, this other neural network NN2 can be used to perform a conversion opposite to the conversion performed by the image converting device 1 using the artificial neural network NN1. Thus, in the present case, the other artificial neural network NN2 can be used to convert an image having the second dynamic range Δ₂ (here a High Dynamic Range) into an image having the first dynamic range Δ₁ (here a Standard Dynamic Range).

The system of FIG. 5 includes the statistical module 4, the sweeping module 6 and the artificial neural network NN1 described above with reference to FIG. 1.

The system of FIG. 5 also includes another statistical module 64, a memory module 66, the other neural network NN2 and another cost estimator 68.

The other statistical module 64 is configured to determine a statistical value based on pixel values (representing at least part of an image) received at its input, as explained below. In the present embodiment, the other statistical module 64 performs the same function as the statistical module 4, and reference can thus be made to the description of the statistical module 4 made above.

The other artificial neural network NN2 includes an input layer 71 comprising three pixel input nodes 76 and at least one statistic input node 75.

The other artificial neural network NN2 includes an output layer 73 comprising three output nodes 77.

In the present example, the other artificial neural network NN2 includes a hidden layer 72 connected to the input layer 71 on the one side and to the output layer 73 on the other side.

In the present embodiment, the other artificial neural network NN2 has the same structure has the artificial neural network NN1 and reference can thus be made to the above description of the artificial neural network NN1 for further details on the other artificial neural network NN2.

The other artificial neural network NN2 can be used (in replacement of artificial neural network NN1) in an image converting device as described above with reference to FIG. 1 to convert an input image into an output image.

Thanks to the training described below, the other artificial neural network NN2 is designed such that, when converting a given image using the image converting device 1 (including the artificial neural network NN1) to obtain a first resulting image, and then converting this first resulting image using an image converting device including the other artificial network NN2 to obtain a second resulting image, the second resulting image will be similar to the given image.

Reference images I_{ref} used to train the artificial neural network NN1 (as explained above) may also be used to train the other artificial neural network NN2. These reference images can thus be obtained thanks to steps S2, S4 and S6 described above.

To train the other artificial neural network NN2, reference images I_{ref} are successively processed by the system of FIG. 5. The process applied to a particular reference image I_{ref} in this context is now described.

The statistical module 4 determines a statistical value s_{ref} associated with the reference image I_{ref}. As explained above, the statistical value s_{ref} is for instance a measure of central tendency (e.g. the average or the median) of the pixel values of at least one component (here the pixel values of the luminance component Y_{ref}) of the reference image I_{ref}.

The statistical module 4 applies the determined statistical value s_{ref} to the (statistic) input node 25 of the artificial neural network NN1.

While the determined statistical value s_{ref} is applied to the (statistic) input node 25 of the artificial neural network NN1, the sweeping module 6 successively considers the various pixels of the reference image I_{ref} and applies the pixel values Y_{ref}(i), Cb_{ref}(i), Cr_{ref}(i) defining the three components Y_{ref}, Cb_{ref}, Cr_{ref} of the reference image I_{ref} for the considered pixel, respectively to the three (pixel) input nodes 26 of the artificial neural network NN1.

As explained above, each time three pixel values Y_{ref}(i), Cb_{ref}(i), Cr_{ref}(i) are applied to the three (pixel) input nodes 26, corresponding pixel values Yₜᵣₙ(i), Cbₜᵣₙ(i), Crₜᵣₙ(i) defining the (three) components of a pixel of a training output image Oₜᵣₙ are respectively produced at the output nodes 27.

The memory module 66 stores the pixel values Yₜᵣₙ(i), Cbₜᵣₙ(i), Crₜᵣₙ(i) successively (i.e. sequentially) produced at output nodes 27 as the sweeping module 6 goes through all the pixels of the reference image I_{ref} (which makes it possible to store all the pixel values Yₜᵣₙ(i), Cbₜᵣₙ(i), Crₜᵣₙ(i) defining the (three) components of the training output image Oₜᵣₙ).

The other statistical module 64 determines a statistical value sₜᵣₙ associated with the training output image Oₜᵣₙ, based on pixel values defining this training output image Oₜᵣₙ, here based on pixel values Yₜᵣₙ(i) of the luminance component of the training output image Oₜᵣₙ. This statistical value strn is for instance a measure of central tendency (e.g. the average or, in a possible variation, the median) of pixel values Yₜᵣₙ(i) of the luminance component of the training output image Oₜᵣₙ.

The other statistical module 64 applies the determined statistical value sₜᵣₙ to the (statistic) input node 75 of the other artificial neural network NN2.

While the determined statistical value sₜᵣₙ is applied to the (statistic) input node 75 of the other artificial neural network NN2, the memory module 66 sequentially considers the pixels of the training output image Oₜᵣₙ and applies, for each pixel i, the pixel values Yₜᵣₙ(i), Cbₜᵣₙ(i), Crₜᵣₙ(i) of the (three) components of the training output image Oₜᵣₙ to the corresponding (pixel) input nodes 76 of the artificial neural network NN2.

Each time a triplet of pixel values is applied on the (pixel) input nodes 76, a triplet of pixel values Y_{rnd}(i), Cb_{rnd}(i), Cr_{rnd}(i) is produced on respective output nodes 77 of the other artificial neural network NN2. The sequence of triplets of pixel values Y_{rnd}(i), Cb_{rnd}(i), Cr_{rnd}(i) obtained when the memory module 66 goes over the pixels of the training output image Oₜᵣₙ defines a roundtrip image I_{rnd}.

As noted above, it is sought here to obtain (after training) a roundtrip image I_{rnd} as close as possible as the reference image I_{ref}.

In this goal, the cost estimator 56 receives pixels values Y_{ref}(i), Cb_{ref}(i), Cr_{ref}(i) defining the reference image I_{ref} and pixel values Y_{rnd}(i), Cb_{rnd}(i), C_{rnd}(i) defining the roundtrip image I_{rnd}, estimates a loss (or cost function) between the reference image I_{ref} and the roundtrip image I_{rnd} and controls an adjustment of the weights of the neurons of the other artificial neural network NN2 to reduce this loss (in accordance with a back-propagation technique).

The cost function used for determining the loss (based on pixels values Y_{ref}(i), Cb_{ref}(i), Cr_{ref}(i) of the reference image I_{ref} and pixel values Y_{rnd}(i), Cb_{rnd}(i), Cr_{rnd}(i) of the roundtrip image I_{rnd}) is for instance a perceptual (possibly colour) difference metric between the reference image I_{ref} and the roundtrip image I_{rnd}. Examples of difference metrics usable in this context are given above in the frame of the description of the training of the artificial neural network NN1.

Training may then be further performed by successively processing other reference images as just described.

When the other artificial neural network NN2 is trained, it can be used in an image converting device as shown in FIG. 1 and described above (the other artificial neural network NN2 replacing the artificial neural network NN1) to perform a dynamic range conversion, here to convert an image having the second dynamic range Δ₂ into an image having the first dynamic range Δ₁.

1. A method for converting an input image having a first dynamic range into an output image having a second dynamic range distinct from the first dynamic range, said input image being represented by at least a first set of pixel values, said output image being represented by at least a second set of pixel values, the method comprising:
determining at least one statistical value associated with the input image based on the first set of pixel values,
determining at least one of the pixel values included in the second set of pixel values and associated with a given one of the pixel values of the first set of pixel values by applying:
said given pixel value of the first set of pixel values to a first input node of an artificial neural network, and
the determined statistical value to a second input node of the artificial neural network,
the artificial neural network being configured to provide, on an output node, said determined pixel value of the second set of pixel values.

2. The method according to claim 1, wherein a plurality of the pixel values of the second set of pixel values are determined by applying sequentially the pixel values of the first set of pixel values on the first input node while applying the determined statistical value to the second input node.

3. The method according to claim 1,
wherein the first set of pixel values defines a component of the input image,
wherein the second set of pixel values defines a corresponding component of the output image, and
wherein the artificial neural network is configured to receive, on two other input nodes, two other pixel values respectively relating to two other components associated with the input image and to provide, on two other output nodes, two other pixel values respectively relating to two other corresponding components associated with the output image.

4. The method according to claim 1, further comprising:
training the artificial neural network by successively using reference images as the input image, a reference statistical value being determined for each of the reference images, wherein the training uses reference output images respectively obtained from the reference images by dynamic range conversion.

5. The method according to claim 4, wherein the training further comprises:
determining initial images defined by a plurality of components according to a first representation, pixel values of the initial images being uniformly distributed over all possible values relating to said plurality of components, and
converting the initial images defined by the plurality of components respectively into the reference images defined by another plurality of components according to a second representation.

6. The method according to claim 5, wherein the training further comprises applying a reshaping function to the pixel values of initial images such that the initial images correspond to different statistical values.

7. The method according to claim 4, wherein the training comprises adjusting neuron weights of the artificial neural network to reduce a cost function depending on pixel values of the reference output image obtained based on a specific one of the reference images, and pixel values obtained at the output of the artificial neural network when pixel values of the specific one of the reference images are sequentially applied on the first input node of said artificial neural network.

8. The method according to claim 7, wherein the cost function is a perceptual difference metric.

9. The method according to claim 1, further comprising:
training a second artificial neural network by applying:
one of the pixel values of the second set of pixel values to a first node of said second artificial neural network and,
to a second node of said second artificial neural network, a second statistical value associated with the output image and determined on a basis of said second set of pixel values,
the second artificial neural network being configured to provide, on an output node of the second artificial neural network, one pixel value of a third set of pixel values associated with said one pixel value of the second set of pixel values.

10. The method according to claim 9, wherein the training said second artificial neural network further comprises:
adjusting neuron weights of said second artificial neural network to reduce a second cost function depending on pixel values of the third set of pixel values and on pixel values of the first set of pixel values.

11. The method according to claim 10, wherein said second cost function is a perceptual difference metric.

12. An image converting device configured to convert an input image having a first dynamic range into an output image having a second dynamic range distinct from the first dynamic range, said input image being represented by at least a first set of pixel values, said output image being represented by at least a second set of pixel values, the image converting device comprising:
a statistical module configured to determine at least one statistical value associated with the input image based on the first set of pixel values, and
a processing module based on an artificial neural network, the processing module being configured to determine at least one of the pixel values of the second set of pixel values that is associated with a given one of the pixel values of the first set of pixel values by applying:
said given pixel value of the first set of pixel values to a first input node of the artificial neural network, and
the determined statistical value to a second input node of the artificial neural network,
the artificial neural network being configured to provide, on an output node, said determined pixel value of the second set of pixel values.

13. The method according to claim 2,
wherein the first set of pixel values defines a component of the input image,
wherein the second set of pixel values defines a corresponding component of the output image, and
wherein the artificial neural network is configured to receive, on two other input nodes, two other pixel values respectively relating to two other components associated with the input image and to provide, on two other output nodes, two other pixel values respectively relating to two other corresponding components associated with the output image.

14. The method according to claim 2, further comprising:
training the artificial neural network by successively using reference images as the input image, a reference statistical value being determined for each of the reference images, wherein the training uses reference output images respectively obtained from the reference images by dynamic range conversion.

15. The method according to claim 3, further comprising:
training the artificial neural network by successively using reference images as the input image, a reference statistical value being determined for each of the reference images, wherein the training uses reference output images respectively obtained from the reference images by dynamic range conversion.

16. The method according to claim 5, wherein the training comprises adjusting neuron weights of the artificial neural network to reduce a cost function depending on pixel values of the reference output image obtained based on a specific one of the reference images, and pixel values obtained at the output of the artificial neural network when pixel values of the specific one of the reference images are sequentially applied on the first input node of said artificial neural network.

17. The method according to claim 6, wherein the training comprises adjusting neuron weights of the artificial neural network to reduce a cost function depending on pixel values of the reference output image obtained based on a specific one of the reference images, and pixel values obtained at the output of the artificial neural network when pixel values of the specific one of the reference images are sequentially applied on the first input node of said artificial neural network.

18. The method according to claim 2, further comprising:
training a second artificial neural network by applying:
one of the pixel values of the second set of pixel values to a first node of said second artificial neural network and,
to a second node of said second artificial neural network, a second statistical value associated with the output image and determined on a basis of said second set of pixel values,
the second artificial neural network being configured to provide, on an output node of the second artificial neural network, one pixel value of a third set of pixel values associated with said one pixel value of the second set of pixel values.

19. The method according to claim 3, further comprising:
training a second artificial neural network by applying:
one of the pixel values of the second set of pixel values to a first node of said second artificial neural network and,
to a second node of said second artificial neural network, a second statistical value associated with the output image and determined on a basis of said second set of pixel values,
the second artificial neural network being configured to provide, on an output node of the second artificial neural network, one pixel value of a third set of pixel values associated with said one pixel value of the second set of pixel values.

20. The method according to claim 4, further comprising:
training a second artificial neural network by applying:
one of the pixel values of the second set of pixel values to a first node of said second artificial neural network and,
to a second node of said second artificial neural network, a second statistical value associated with the output image and determined on a basis of said second set of pixel values,
the second artificial neural network being configured to provide, on an output node of the second artificial neural network, one pixel value of a third set of pixel values associated with said one pixel value of the second set of pixel values.
